(19) United States
(12) Patent Application Publication
(10) Pub. No.: US 2017/0048681 A1
(43) Pub. Date: Feb. 16, 2017

(54) ON-DEMAND TIME-SHIFTED ACCESS OF BROADCAST CONTENT

(71) Applicant: AT&T INTELLECTUAL PROPERTY I, L.P., Atlanta, GA (US)

(72) Inventors: Gaurav GUPTA, Sammamish, WA (US); Rajendra Prasad KODAYPAK, Sammamish, WA (US)

(21) Appl. No.: 14/823,782

(22) Filed: Aug. 11, 2015

(51) Int. Cl. H04W 4/06; H04N 21/6405

(52) U.S. Cl. CPC H04W 4/06; H04N 21/6405; H04L 12/189

(57) ABSTRACT

On-demand time-shifted access of broadcast content is presented herein. A system can comprise a time-shifted access component that can determine that a mobile device is receiving a broadcast transmission of broadcast content from a broadcast enabled access point device that is configured to send the broadcast content to multiple devices via a point-to-multipoint communication protocol. A storage component can store a copy of the broadcast content in a memory in response to receiving, from the mobile device, an interrupt request to interrupt the broadcast transmission. The time-shifted access component can initiate a transmission of a portion of the copy of the broadcast content to the mobile device in response to receiving a play request from the mobile device. Further, in response to receiving, from the mobile device, a broadcast request to resume the broadcast transmission, the time-shifted access component can halt the transmission and resume the broadcast transmission.

### TECHNICAL FIELD

The subject disclosure generally relates to embodiments for on-demand time-shifted access of broadcast content.

### BACKGROUND

Conventional wireless technologies, such as long term evolution (LTE) evolved Multimedia Broadcast Multicast Service (eMBMS), enable users to access a live broadcast steam of video content using handheld devices. However, such technologies have had some drawbacks with respect to enabling access to different parts of MBMS based content during and/or after its broadcast. Further, conventional wireless technologies have had some drawbacks with respect to enabling access of such content during broadcast service interruptions, and enabling access of such content via non-homogeneous access points.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a time-shifting LTE broadcast access environment, in accordance with various embodiments;

FIG. 2 illustrates a block diagram of a content storage and control system, in accordance with various embodiments;

FIG. 3 illustrates a block diagram of an Internet based time shifting LTE broadcast access environment, in accordance with various embodiments;

FIG. 4 illustrates a block diagram of a mobile device corresponding to a time-shifting LTE broadcast access environment, in accordance with various embodiments;

FIGS. 5-9 illustrate flowcharts of method(s) performed by a content storage and control system, in accordance with various embodiments;

FIG. 10 illustrates a flowchart of a method performed by a mobile device corresponding to a time-shifting LTE broadcast access environment, in accordance with various embodiments; and

FIG. 11 is a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As mentioned, conventional wireless technologies have had some drawbacks with respect to enabling access to different parts of MBMS based content during and/or after its broadcast. Further, such technologies have had some drawbacks with respect to enabling access of MBMS based content during broadcast service interruptions, and via non-homogeneous access points. Various embodiments disclosed herein can provide on-demand, digital-video-recorder (DVR) like access of eMBMS-based broadcast content via unicast enabled access points.

For example, a system can comprise a processor, and a memory that stores executable instructions that, when executed by the processor, facilitate performance of operations, comprising: determining that a mobile device is receiving a broadcast transmission, e.g., an LTE eMBMS based transmission, of broadcast content, e.g., a live video feed of a sports and/or news event, a digital television (TV) stream, a pre-recorded video stream, etc. from a broadcast enabled access point device that is configured to send the broadcast content to multiple devices via a point-to-multipoint communication protocol, e.g., corresponding to an LTE eMBMS video broadcast service, etc.

Further, in response to receiving, from the mobile device, an interrupt, suspend, pause, etc. request to interrupt, suspend, pause, etc. the broadcast transmission, the operations can comprise storing a copy of the broadcast content in a memory, buffer, storage device, etc. Furthermore, in response to receiving a play, resume, etc. request from the mobile device, the operations can comprise initiating a transmission of a portion of the copy of the broadcast content to the mobile device, e.g., utilizing a unicast enabled access point device that is configured to send the copy of the broadcast content to the mobile device via a point-to-point communication protocol, e.g., via a unicast transmission.

In an embodiment, the broadcast enabled access point device, e.g., an MBMS white cell that has been configured, but not licensed, to send an eMBMS broadcast transmission, comprises the unicast enabled access point device. In another embodiment, the unicast enabled access point device comprises a universal mobile telecommunication system (UMTS) terrestrial radio access network (UTRAN) based access point. In yet another embodiment, the unicast enabled access point device comprises an Institute of Electrical and Electronics Engineers (IEEE) 802.XX based access point device, e.g., a Wi-Fi access point, a Bluetooth access point, etc.

In an embodiment, the storing the copy and the initiating the transmission are further in response to determining that the mobile device is not receiving the broadcast transmission, e.g., based on a detected handover request, based on a message received from the mobile device, etc.

In one embodiment, the operations can comprise sending a portion of the copy of the broadcast content directed to a device, e.g., another mobile device (e.g., corresponding to a family calling plan associated with the mobile device), in response to receiving, from the other mobile device, a request to access the copy of the broadcast content.

In another embodiment, the operations can comprise halting the transmission of the portion of the copy of the broadcast content and resuming the broadcast transmission of the broadcast content from the broadcast enabled access point device to the mobile device in response to receiving, from the mobile device, a request to resume the broadcast transmission, e.g., via a request to fast forward to the end of the copy of the broadcast content.

In yet another embodiment, a method can comprise: determining, by a system comprising a processor, that a user equipment (UE) is receiving a broadcast transmission of multimedia content, e.g., a live video feed of a sports or news event, a digital TV stream, a pre-recorded video stream, etc. from a broadcast access point device that is configured to send the broadcast transmission to multiple devices via a point-to-multipoint wireless communication protocol, e.g., via an LTE eMBMS based protocol.

Further, the method can comprise storing, by the system, a copy of the multimedia content in a memory in response to receiving, by the system, a first request to interrupt, e.g., pause, stop, etc. the broadcast transmission. Furthermore, the method can include sending, by the system, e.g., via a unicast transmission, via an IEEE 802.XX based transmission, etc. a portion of the copy of the multimedia content directed to the UE in response to receiving, by the system, a second request from the UE to access the multimedia content.

In an embodiment, the operations can further comprise ending, suspending, canceling, etc. the sending of the portion of the copy of the multimedia content, and resuming, e.g., via the broadcast access point device, via another broadcast access point device, etc. the broadcast transmission of the multimedia content to the user equipment in response to receiving, by the system, a third request from the UE to resume the broadcast transmission.

In one embodiment, the receiving of the second request can further comprise sending, by the system, a unicast transmission of the portion of the copy directed to the UE in response to determining that the UE is not receiving the broadcast transmission.

In another embodiment, the operations can further comprise sending, by the system, a portion of the copy of the multimedia content directed to the device in response to receiving, by the system, a third request from a device to access the multimedia content.

One embodiment can comprise a machine-readable storage medium, comprising executable instructions that, when executed by a processor, facilitate performance of operations, comprising: determining that a mobile device is receiving a broadcast transmission of a data stream via a point-to-multipoint wireless communication protocol; in response to receiving an interrupt request to interrupt the broadcast transmission, storing a copy of the data stream in a memory device; and in response to receiving a content request to access the data stream, sending a portion of the copy directed to the mobile device.

In another embodiment, the sending comprises sending the portion of the copy directed to the mobile device utilizing a unicast transmission.

In an embodiment, the operations further comprise halting, suspending, etc. the sending of the portion of the copy of the multimedia content, and resuming the broadcast transmission of the data stream to the mobile device in response to receiving a request from the mobile device to resume the broadcast transmission,

In one embodiment, the operations can further comprise sending a portion of a copy of the data stream directed to a device, e.g., associated with a calling plan corresponding to the UE, in response to receiving a request from the device to access the copy of the data stream.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, terms “component,” “function”, “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

In accordance with various embodiments, processor(s) for implementing embodiments disclosed herein can comprise distributed processing devices, or parallel processing devices, in a single machine, device, etc., or across multiple machines, devices, etc. Furthermore, the processor(s) can comprise a state machine, an application specific integrated circuit (ASIC), or a programmable gate array (PGA), e.g., field PGA (FPGA). In this regard, when the processor(s) execute instruction(s) to perform “operations”, the processor(s) can perform the operations directly, and/or facilitate, direct, or cooperate with other device(s) and/or component(s) to perform the operations.

In accordance with various aspects of the subject specification, artificial intelligence based systems, components, etc. can employ classifier(s) that are explicitly trained, e.g., via a generic training data, as well as implicitly trained, e.g., via observing characteristics of communication equipment, e.g., a network device, a gateway, a wireless communication device, etc., by receiving reports from such communication equipment, by receiving operator preferences, by receiving historical information, by receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by content storage and control (CSC) system 110 (see below), comprising, but not limited to, determining that a mobile device is receiving a broadcast transmission of broadcast content from a broadcast enabled access point device that is configured to send the broadcast content to multiple devices via a point-to-multipoint communication protocol; in response to receiving, from the mobile device, an interrupt request to interrupt, suspend, pause, etc. the broadcast transmission, storing a copy of the broadcast content in a memory; and in response to receiving a play request from the mobile device, initiating a transmission of a first portion of the copy of the broadcast content to the mobile device.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

For example, the classifier(s) can be used by the artificial intelligence system, e.g., CSC system 110 (see below), to automatically receive, monitor, review, etc. network information, e.g., representing communication traffic conditions, etc. corresponding to a broadcast transmission directed to a mobile device, to determine whether the mobile device is receiving the broadcast transmission.

As used herein, the term “infer” or “inference” refers generally to the process of reasoning about, or inferring states of, the system, environment, user, and/or intent from a set of observations as captured via events and/or data. Captured data and events can comprise user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Aspects, features, and/or advantages of the disclosed subject matter can be exploited in substantially any wired telecommunication technology and/or any wireless telecommunication or radio technology, e.g., Institute of Electrical and Electronics Engineers (IEEE) 802.XX technology, e.g., Wi-Fi, Bluetooth, etc; worldwide interoperability for microwave access (WiMAX); enhanced general packet radio service (GPRS); third generation partnership project (3GPP) LTE; third generation partnership project 2 (3GPP2); ultra mobile broadband (UMB); 3GPP UMTS; high speed packet access (HSPA); high speed downlink packet access (HSDPA); high speed uplink packet access (HSUPA); LTE advanced (LTE-A), global system for mobile communication (GSM), near field communication (NFC), Wibree, Wi-Fi Direct, etc.

Further, selections of a radio technology, or radio access technology, can comprise second generation (2G), third generation (3G), fourth generation (4G), etc. evolution of the radio access technology; however, such selections are not intended as a limitation of the disclosed subject matter and related aspects thereof. Further, aspects, features, and/or advantages of the disclosed subject matter can be exploited in disparate electromagnetic frequency bands. Moreover, terms like “user equipment,” “mobile station,” “mobile device,” “mobile subscriber station,” “access terminal,” “terminal”, “handset,” “appliance,” “machine,” “wireless communication device,” “cellular phone,” “personal digital assistant,” “smartphone,” “wireless device”, and similar terminology refer to a wired and/or wireless device, or wired and/or wireless communication device, which is at least one of (1) utilized by a subscriber of a wired and/or wireless service, communication service, etc. to receive and/or convey data associated with voice, video, sound, and/or substantially any data-stream or signaling-stream; or (2) utilized by a subscriber of a voice over IP (VoIP) service that delivers voice communications over IP networks such as the Internet or other packet-switched networks. Further, the foregoing terms are utilized interchangeably in the subject specification and related drawings.

Likewise, the terms “local wireless communications cite,” “access point” (AP), “base station,” “Node B,” “eNodeB” (eNB), and the like are utilized interchangeably in the subject specification and drawings and refer to a wireless network component or apparatus that sends and/or receives data associated with voice, video, sound, and/or substantially any data-stream or signaling-stream between a set of subscriber stations and/or to/from a wireless communication device—unless context warrants particular distinction(s) among the terms. Further, the data and signaling streams can be packetized or frame-based flows.

A communication network, e.g., corresponding to a time-shifting LTE broadcast access environment (see e.g., 100, 300), for systems, methods, and/or apparatus disclosed herein can comprise any communication network, e.g., mobile and/or wire line-based circuit-switched communication network, etc. comprising, e.g., a global systems for mobile communication (GSM) network, a time division multiple access (TDMA) network, a code division multiple access (CDMA) network, such as IS-95 and subsequent iterations of CDMA technology, an integrated digital enhanced network (iDEN) network, a public switched telephone network (PSTN), etc. Further, examples of the communication network can comprise any suitable data packet-switched or combination data packet/circuit-switched communication network, wired or wireless IP network such as a VoLTE network, a VoIP network, an IP data network, a UMTS network, a general packet radio service (GPRS) network, or other communication networks that provide streaming data communication over IP and/or integrated voice and data communication over combination data packet/circuit-switched technologies.

Similarly, one of ordinary skill in the art will appreciate that a communication device, UE, etc. (see e.g., UE 114, UE 314) for systems, methods, and/or apparatus disclosed herein can comprise a wireless device, a wired device, e.g., physically coupled to the communication network, a mobile device, a mobile phone, a 2G, 3G, 4G, . . . , etc. cellular communication device, a PSTN phone, a cellular communication device, a cellular phone, a satellite communication device, a satellite phone, a VoIP phone, Wi-Fi phone, a dual-mode cellular/Wi-Fi phone, a combination cellular/VoIP/Wi-Fi/WiMAX phone, a smartphone, a laptop device, a tablet device, a television device, a vehicle device, a home security system device, a portable computer, a wireless system, a sensor, or any suitable combination thereof. Specific examples of the communication device can comprise, but are not limited to, a cellular device, such as a GSM, TDMA, CDMA, IS-95 and/or iDEN phone, a cellular/Wi-Fi device, such as a dual-mode GSM, TDMA, IS-95 and/or iDEN/VoIP phones, UMTS phones, UMTS VoIP phones, a Wibree based device, or like devices or combinations thereof.

As mentioned, conventional wireless technologies have had some drawbacks with respect to enabling access to different parts of MBMS based content during and/or after its broadcast. Further, such technologies have had some drawbacks with respect to enabling access of MBMS content during broadcast service interruptions, and via non-homogeneous access points.

On the other hand, various embodiments disclosed herein can provide on-demand, DVR like access of eMBMS-based broadcast content by saving a copy of such content during its broadcast for later, e.g., time-shifted, access, e.g., via non-homogeneous access points.

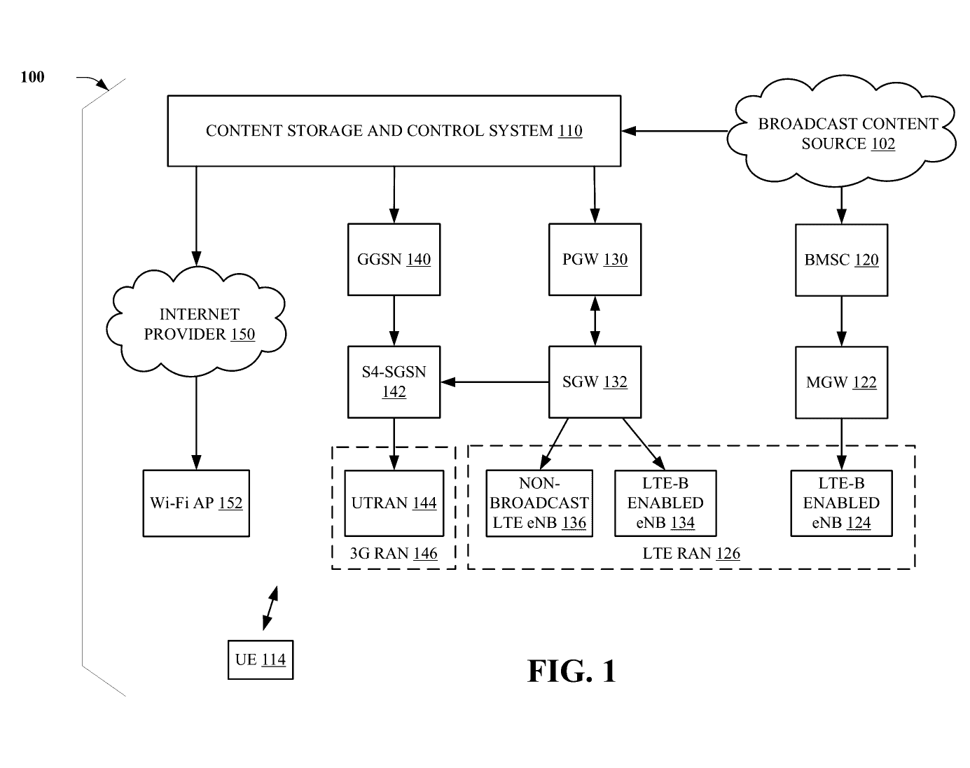

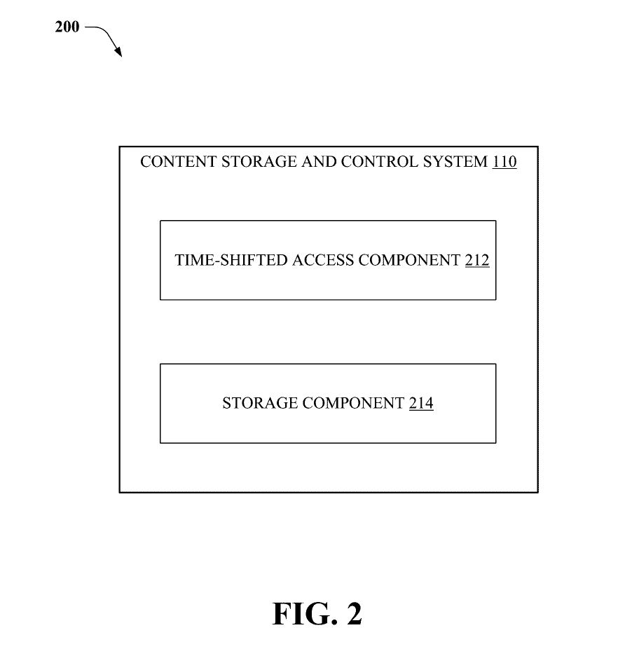

In this regard, and now referring to FIGS. 1-3, CSC system 110 can comprise time-shifted access component 212 and storage component 214. Time-shifted access component 212 can determine that a mobile device, e.g., UE 114, is receiving a broadcast transmission of broadcast content, e.g., corresponding to an LTE eMBMS based transmission, e.g., a live video feed of a sports and/or news event, a digital TV stream, a pre-recorded video stream, etc. from a broadcast enabled access point device of LTE radio access network (RAN) 126, e.g., LTE-Broadcast (LTE-B) enabled eNB 124, LTE-B enabled eNB 134, etc.—the broadcast enabled access point device being configured to send the broadcast content to multiple devices via a point-to-multipoint, one-to-multiple, etc. communication protocol.

In embodiment(s), a broadcast enabled device, e.g., the mobile device, etc. can receive the broadcast transmission in an evolved packet system (EPS) connected state, e.g., in an ECM_IDLE mode, e.g., in which a signaling connection between the mobile device and a mobility management entity (MME) has been released or broken, or in an ECM_CONNECTED mode, e.g., in which the signaling connection exists. In this regard, since an operator network does not have direct visibility into how many devices are receiving the broadcast content, etc., time-shifted access component 212 can determine that the mobile device is receiving the broadcast transmission based on request(s) received from the mobile device to interrupt, pause, suspend, etc. the broadcast transmission.

In one embodiment, storage component 214 can store a copy of the broadcast content in a memory, data storage buffer, etc. (not shown) in response to receiving, from the mobile device, an interrupt request to interrupt, pause, suspend, etc. the broadcast transmission. In this regard, time-shifted access component 212 can initiate a transmission of a portion of the copy of the broadcast content to the mobile device in response to receiving a play request from the mobile device, e.g., corresponding to an instruction to play, or resume, the portion of the broadcast content, e.g., that had been interrupted, paused, suspended, etc.; corresponding to an instruction to rewind (RW), or seek, to the portion of the broadcast content, e.g., that had been broadcasted at time earlier than a referenced time period; e.g., corresponding to an instruction to fast forward (FFW), or seek, to the portion of the broadcast content, e.g., that has been broadcasted at a time later than the referenced time period.

In another embodiment, time-shifted access component 212 can initiate a unicast transmission of the portion of the copy from a unicast enabled access point device, e.g., corresponding to LTE RAN 126 (e.g., LTE-B enabled eNB 124, LTE-B eNB 134, non-broadcast enabled LTE eNB 136—an LTE reserved cell with eMBMS capability that is not licensed for LTE-B service); corresponding to 3G RAN 146 (e.g., UTRAN 144); corresponding to Internet provider 150 (e.g., Wi-Fi AP 152), etc. In this regard, the unicast enabled access point device is configured to send the copy of the broadcast content to a single device, e.g., UE 114, via a point-to-point, one-to-one, etc. communication protocol.

In one embodiment, in response to time-shifted access component 212 receiving, from the mobile device, a broadcast request to resume the broadcast transmission, time-shifted access component 212 can halt the transmission of the portion of the copy of the broadcast content, and resume the broadcast transmission, e.g., via LTE-B enabled eNB 124, LTE-B enabled eNB 134, etc.

In another embodiment, the broadcast request can comprise a FFW request to fast forward, or seek, to the portion of the broadcast content that has been recently broadcasted, e.g., that has been copied to the end of the data storage buffer. In this regard, time-shifted access component 212 can switch from sending stored broadcast content to the mobile device, to resuming the broadcast transmission to the mobile device based on the FFW request.

In yet another embodiment, storage component 214 can store the copy of the broadcast content in the memory, and time-shifted access component 212 can initiate the unicast transmission of the portion of the copy from the unicast enabled access point device in response to a determination, by CSC system 110, that the mobile device is not receiving the broadcast transmission, e.g., based on a detected handover request corresponding to the mobile device, based on a message received from the mobile device, etc. In this regard, CSC system 110 can improve customer experiences by enabling, via non-homogeneous access points, access of MBMS based content during broadcast service interruptions during loss of MBMS coverage due to client mobility, etc.

To provide support for CSC system 110, time shifting LTE broadcast access environment 100 comprises broadcast multicast service center (BMSC) 120 and MBMS gateway (MGW) 122. BMSC 120 receives the broadcast content from broadcast content source 102, e.g., a digital TV provider, a telecommunication service provider, a news provider, etc. In this regard, BMSC 120 provides an interface, e.g., billing interface, content interface, etc. for content providers with respect to live video feeds, streams, etc. and/or pre-recorded video feeds, streams etc. comprising, e.g., generic files, moving picture experts group (MPEG) dynamic adaptive streaming over hypertext transfer protocol (MPEG-DASH) video streams, etc. that are to be broadcast via time shifting LTE broadcast access environment 100. Further, coupled to BMSC 120, MGW 122 can deliver such feeds, streams, etc. to access points, e.g., LTE-B enabled eNB 124 of LTE RAN 126.

CSC system 110 can initiate the unicast transmission from the unicast enabled access point device by triggering, initiating, etc. an equivalent bearer setup with public data network gateway (PGW) 130 to facilitate the unicast transmission of the broadcast content from a unicast enabled access point device, e.g., LTE-B enabled eNB 134, non-broadcast enabled LTE eNB 136, etc. to the mobile device. In this regard, PGW 130 can perform policy enforcement regarding access of network services and charging support, and is coupled to serving gateway (SGW) 132, which can route, forward, etc. user data packets/traffic to UE 214 via LTE RAN 126.

Further, SGW 132 can be coupled to S4-serving general packet radio service support node (SGSN) 142, which can perform transfer, mobility management, and authentication and charging functions, and route eMBMS-based traffic, e.g., the broadcast content, to non-broadcast enabled UTRAN AP 144 of 3G RAN 146. S4-SGSN 142 is coupled to gateway general packet radio service (GPRS) support node (GGSN) 140, which performs authentication and charging functions, and maintains routing to tunnel protocol data units (PDUs) to S4-SGSN 142.

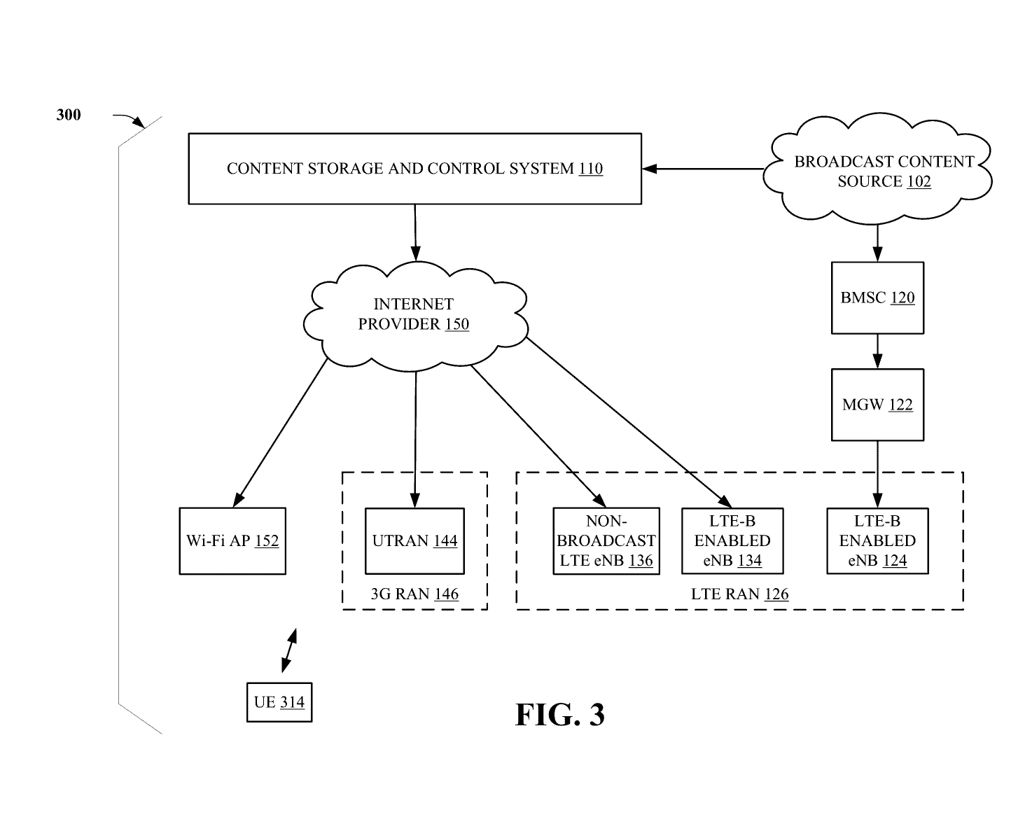

Now referring to FIG. 3, a block diagram of an Internet based time shifting LTE broadcast access environment (300) is illustrated, in accordance with various embodiments. As illustrated by FIG. 3, time-shifted access component 212 can send a portion of the copy of the broadcast content to another device in response to receiving, from the other device, a request to access the copy of the broadcast content, e.g., UE 314 corresponding to a calling plan of the mobile device.

In this regard, CSC system 110 enables playback of the stored broadcast content across multiple wired and/or wireless devices, e.g., corresponding to a “family calling plan.” For example, such playback can be independent of the broadcast content received by the mobile device, and multiple wired and/or wireless devices can access different portions of the copy of the broadcast content at different times. For example, as illustrated by FIG. 3, UE 314 is capable of accessing the stored broadcast content associated with UE 114 via Internet provider 150, which can provide such content to Wi-Fi AP 152, UTRAN 144, non-broadcast enabled LTE eNB 136, and/or LTE-B enabled eNB 134 utilizing an Internet protocol based communication.

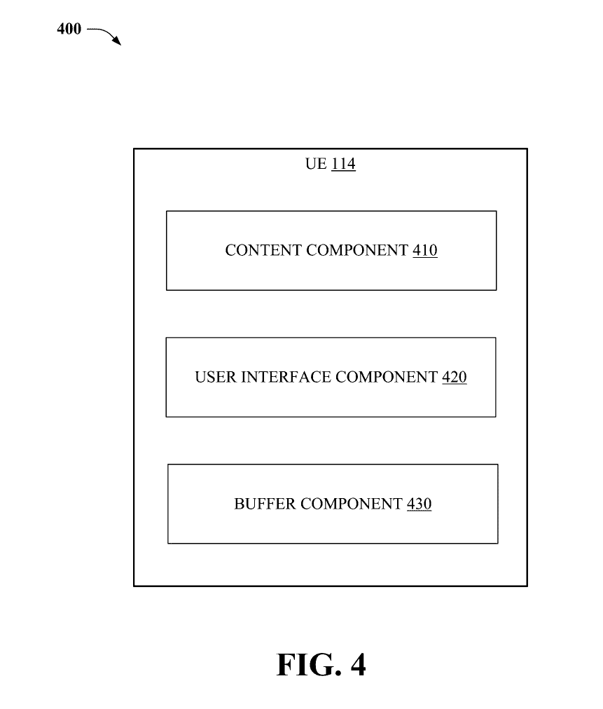

Referring now to FIG. 4, a block diagram of UE 114 corresponding to a time-shifting LTE broadcast access environment (see e.g., 100, 300) is illustrated, in accordance with various embodiments. UE 114 comprises content component 410, user interface (UI) component 420, and buffer component 430. Content component 410 can receive a broadcast transmission of broadcast content from a broadcast enabled access point device of a broadcast enabled communication system (see e.g., 100, 300)—the broadcast enabled access point device configured to send the broadcast content to multiple devices via a point-to-multipoint communication protocol. In an embodiment, UE 114 can include middleware comprising a DASH client for decoding a broadcast stream of the broadcast transmission for playback via UE 114.

UI component 420 can detect an interrupt user input, e.g., via a device interface (not shown) of UE 114, e.g., a touch interface, a voice activated interface, etc. The interrupt user input can correspond to a user request, interrupt request, etc. to interrupt, pause, suspend, etc. the broadcast transmission being received by UE 114. In this regard, in response to detecting the interrupt request, content component 410 can send an interrupt message directed to the broadcast enabled communication system, e.g., directed to CSC system 110, to initiate storage of a copy of the broadcast transmission. In an embodiment, the interrupt message can comprise an identification (ID), e.g., cell number, of UE 114, and information representing a content stream of the broadcast transmission being received by UE 114.

Further, UI component 420 can receive, detect, etc., via the device interface, a play user input corresponding to a play, FFW, RW, etc. request to receive a portion of the broadcast content corresponding to the referenced time period described above. In this regard, in response to detecting such request, content component 410 can send an access message directed to the broadcast enabled communication system, e.g., directed to CSC system 110, to initiate transmission, by CSC system 110, of a portion of the copy of the broadcast transmission from a unicast enabled access point device, the unicast enabled access point device being configured to send the copy of the broadcast transmission to the mobile device via a point-to-point communication protocol.

Content component 410 can receive the portion of the copy from the unicast enabled access point device, and store such portion in buffer component 430, e.g., comprising a memory, a data storage device, etc. In this regard, the middleware can retrieve portions(s) of the copy received from the unicast enabled access point device to enable “seamless” playback of such content via UE 114.

In another embodiment, in response to UI component 420 detecting, receiving, etc., via the device interface, a resume user input corresponding to a resume request to continue receiving the broadcast transmission, e.g., via the broadcast enabled access point device, via another broadcast enabled access point device, etc., content component 410 can send a resume message directed to the broadcast enabled communication system, e.g., directed to CSC system 110, to initiate halting of the transmission of the portion of the copy of the broadcast transmission, and resume receiving the broadcast transmission. In this regard, content component 410 can resume receiving the broadcast transmission, e.g., via the broadcast enabled access point device, via another broadcast enabled access point device, etc.

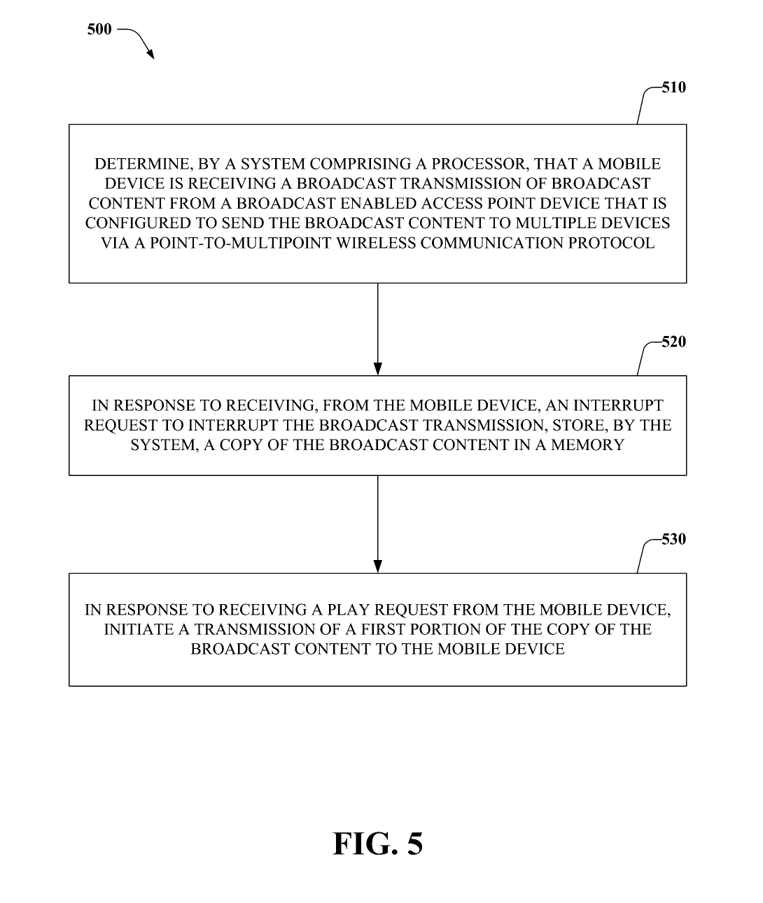

FIGS. 5-10 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 5, process 500 performed by a system comprising a processor, e.g., CSC system 110, is illustrated, in accordance with various embodiments. At 510, it can be determined that a mobile device, UE, etc. is receiving a broadcast transmission of broadcast content, e.g., broadcast data associated with an LTE eMBMS video broadcast service, etc. from a broadcast enabled AP that is configured to send the broadcast content to multiple devices via a point-to-multipoint wireless communication protocol.

At 520, in response to receiving, from the mobile device, an interrupt request to interrupt, pause, suspend, etc. the broadcast transmission, a copy of the broadcast transmission can be stored in a memory.

At 530, in response to receiving, from the mobile device, a play request, e.g., corresponding to a FFW, RW, play, etc. request to receive a portion of the broadcast content corresponding to a defined time period of the broadcast content, initiating a transmission, a unicast transmission, etc. of a first portion of the copy of the broadcast content to the mobile device, e.g., via a unicast enabled AP that is configured to send the copy of the broadcast content to the mobile device via a point-to-point communication protocol.

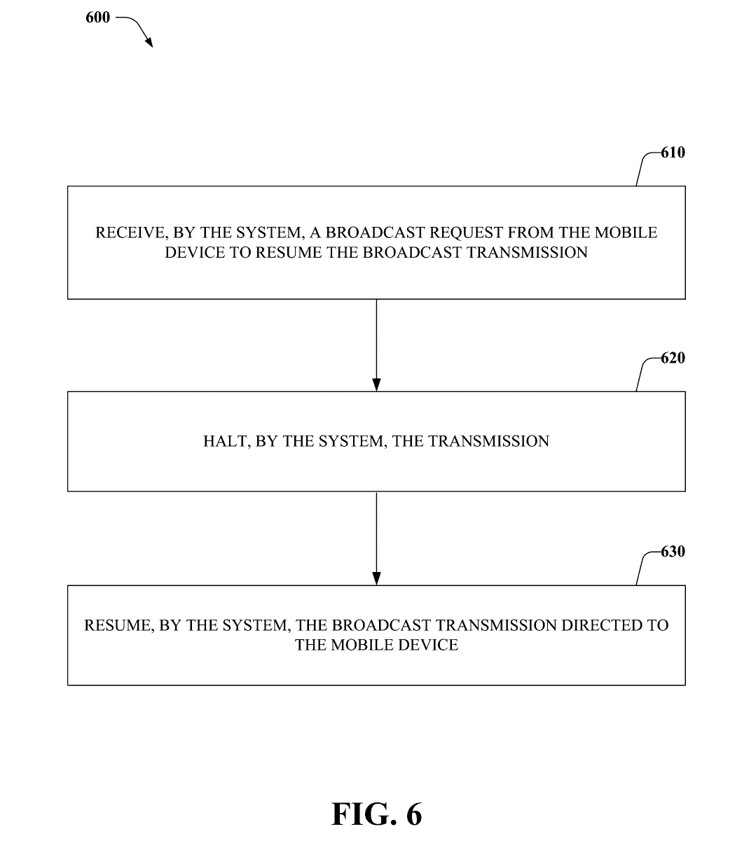

FIG. 6 illustrates another process (600) performed by the system, e.g., CSC system 110, in accordance with various embodiments. At 610, a broadcast request to resume the broadcast transmission can be received from the mobile device. At 620, in response to receiving the broadcast request, the transmission, unicast transmission, etc. of the copy of the broadcast content can be halted. At 630, the broadcast transmission of the broadcast content directed to the mobile device can be resumed.

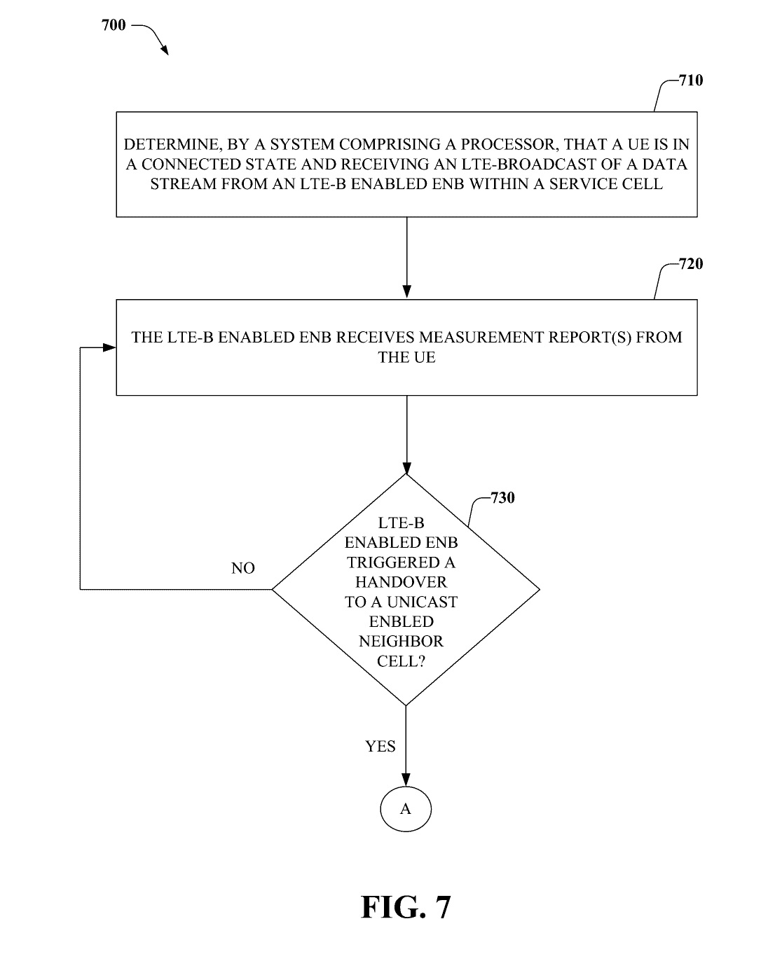

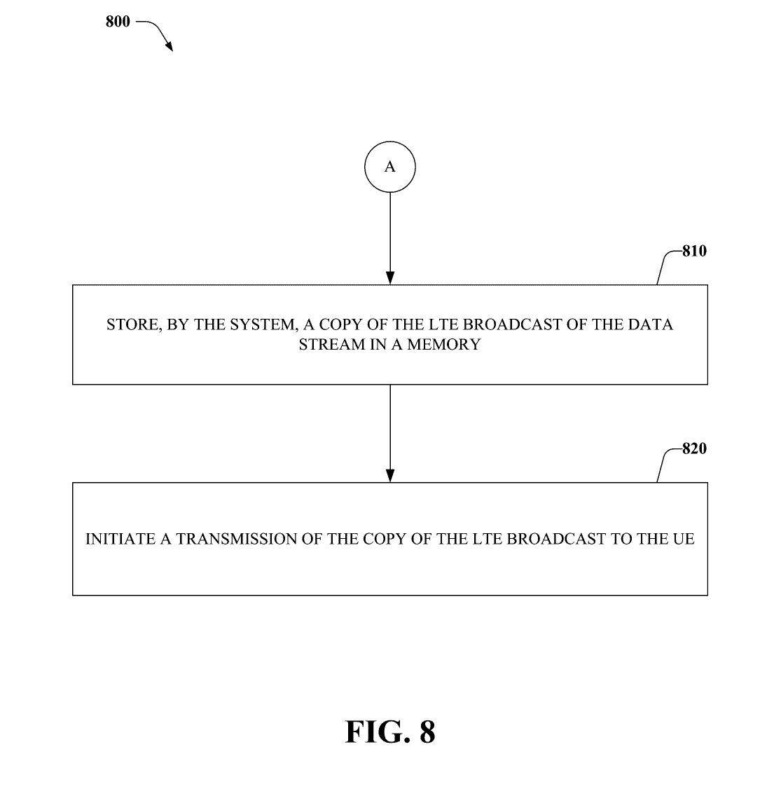

FIGS. 7-8 illustrate other processes (700-800) performed by the system, e.g., CSC system 110, in accordance with various embodiments. At 710, it can be determined that a UE is in a connected state and receiving an LTE broadcast of a data stream, broadcast content, etc. from an LTE-B enabled eNB within a service cell. At 720, LTE-B enabled eNB can receive measurement report(s) from the UE, and based on such reports, determine whether to trigger a handover to a neighbor cell. At 730, it can be determined whether the LTE-B enabled ENB triggered a handover to a unicast enabled neighbor cell.

If it is determined that the LTE-B enabled eNB triggered the handover to the unicast enabled neighbor cell, flow continues to 810, at which a copy of the LTE broadcast of the data stream, broadcast content, etc. can be stored in a memory; otherwise flow returns to 720. Flow continues from 810 to 820, at which a transmission of the copy of the LTE broadcast of the data stream to the UE can be initiated.

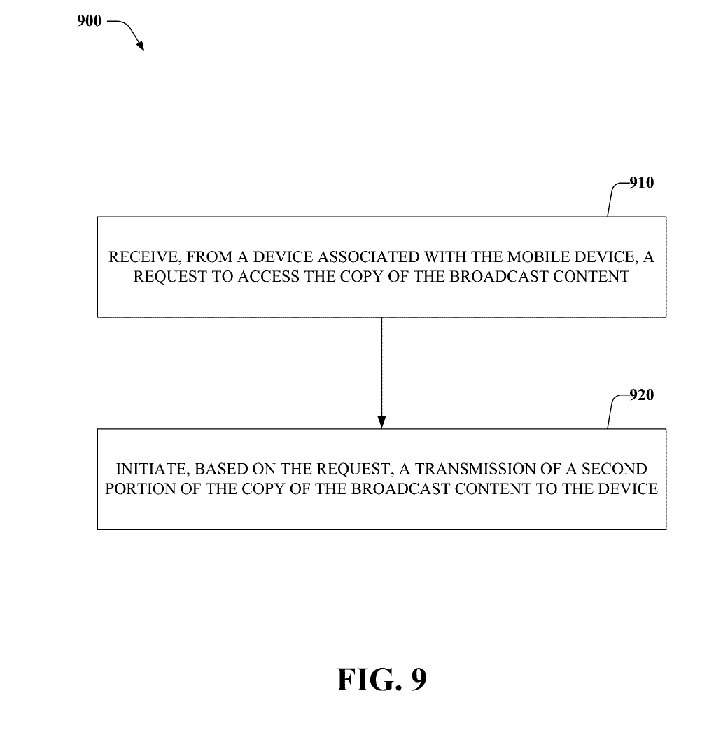

FIG. 9 illustrates a process (900) performed by the system, e.g., CSC system 110, corresponding to a time shifting LTE broadcast access environment, in accordance with various embodiments. At 910, a request to access the copy of the LTE broadcast of the data stream, broadcast content, etc. can be received from a device associated with the UE, e.g., the device corresponding to a calling plan, family calling plan, etc. of the UE. At 920, based on the request, a transmission of a requested portion of the broadcast content to the device can be initiated. In this regard, multiple wired and/or wireless devices, e.g., corresponding to a family calling plan, can independently access different portions of the copy of the LTE broadcast of the data stream, broadcast content, etc. at different times—independent of the broadcast content being received by the UE.

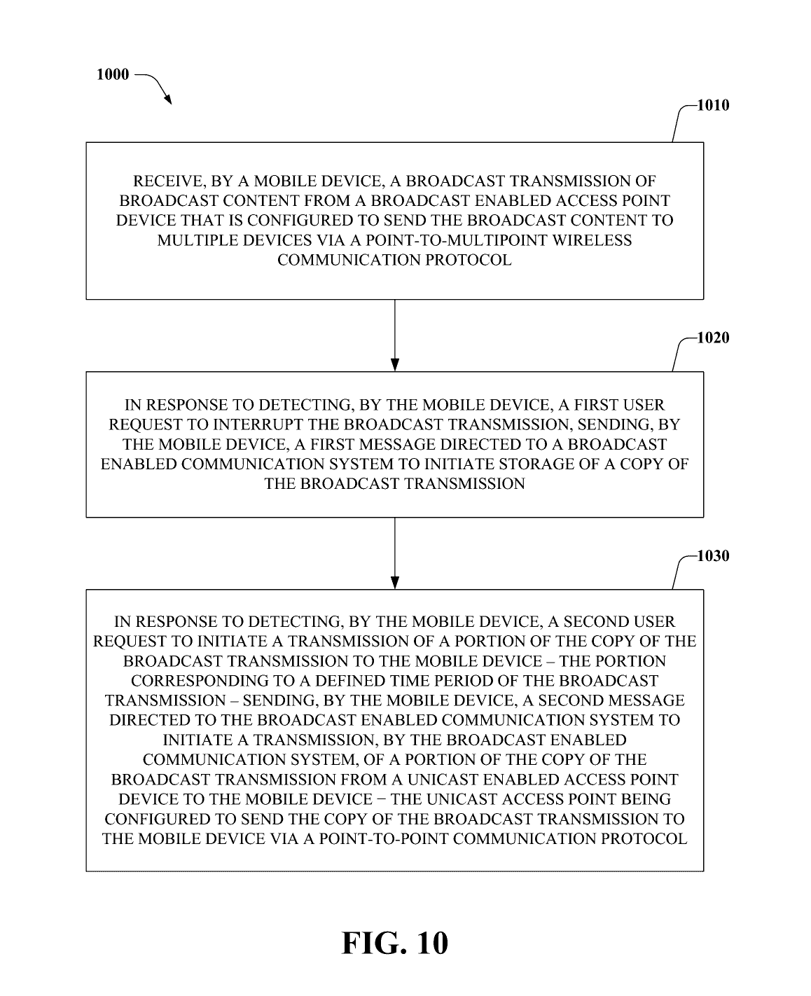

Referring now to FIG. 10, a flowchart of a process (1000) performed by a mobile device, e.g., UE 114, UE 314, etc. corresponding to a time-shifting LTE broadcast access environment (e.g., 100, 300) is illustrated, in accordance with various embodiments. At 1010, a broadcast transmission of broadcast content can be received, by the mobile device, from a broadcast enabled access point device that is configured to send the broadcast content to multiple devices via a point-to-multipoint wireless communication protocol.

At 1020, a first message directed to a broadcast enabled communication system (e.g., 110) can be sent by the mobile device to initiate storage of a copy of the broadcast transmission in response to detecting, by the mobile device, a first user request to interrupt the broadcast transmission.

At 1030, a second message directed to the broadcast enabled communication system can be sent by the mobile device to initiate a transmission, by the broadcast enabled communication system, of a portion of the copy of the broadcast transmission from a unicast enabled access point device to the mobile device in response to detecting, by the mobile device, a second user request to initiate the transmission of the portion of the copy of the broadcast transmission—the portion corresponding to a defined time period of the broadcast transmission, and the unicast enabled access point device being configured to send the copy of the broadcast transmission to the mobile device via a point-to-point communication protocol.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium”, and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in non-volatile memory 1122 (see below), disk storage 1124 (see below), memory storage 1146 (see below), storage component 214, and/or buffer component 430. Further, nonvolatile memory can be included in read only memory (ROM), programmable ROM (PROM), electrically programmable ROM (EPROM), electrically erasable ROM (EEPROM), or flash memory. Volatile memory 1120 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

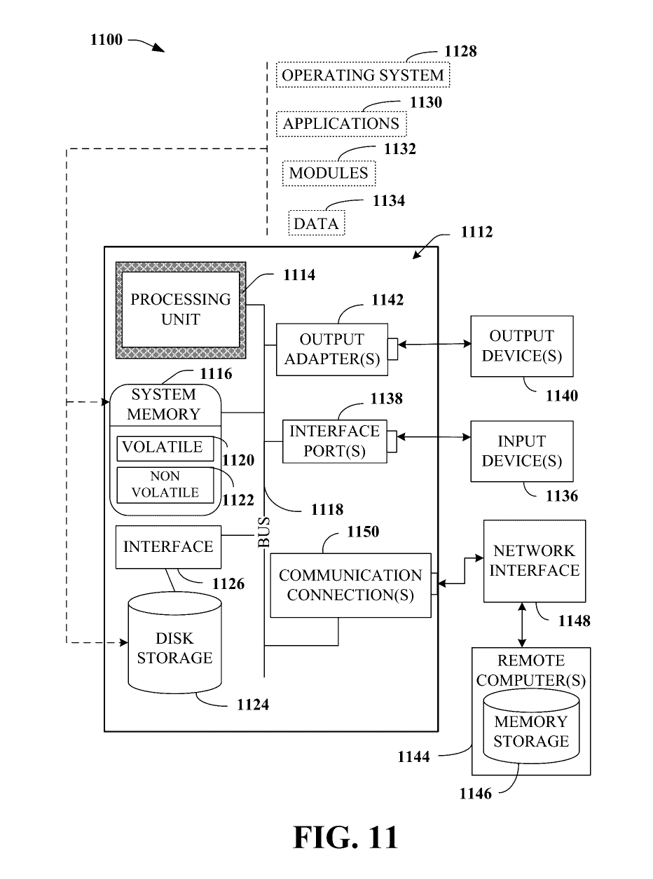

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 11, a block diagram of a computing system 1100 operable to execute the disclosed systems and methods is illustrated, in accordance with an embodiment. Computer 1112 comprises a processing unit 1114, a system memory 1116, and a system bus 1118. System bus 1118 couples system components comprising, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1116 comprises volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can comprise ROM, PROM, EPROM, EEPROM, or flash memory. Volatile memory 1120 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also comprises removable/non-removable, volatile/non-volatile computer storage media. FIG. 11 illustrates, for example, disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software comprises an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands or information into computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1114 through system bus 1118 via interface port(s) 1138. Interface port(s) 1138 comprise, for example, a serial port, a parallel port, a game port, a universal serial bus (USB), a wireless based port, e.g., Wi-Fi, Bluetooth, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140, like display devices, light projection devices, monitors, speakers, and printers, among other output devices 1140, which use special adapters. Output adapters 1142 comprise, by way of illustration and not limitation, video and sound devices, cards, etc. that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically comprises many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically and/or wirelessly connected via communication connection 1150. Network interface 1148 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can comprise, for example, internal and external technologies such as modems, comprising regular telephone grade modems, cable modems and DSL modems, wireless modems, ISDN adapters, and Ethernet cards.

The computer 1112 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1112 can connect to other devices/networks by way of antenna, port, network interface adaptor, wireless access point, modem, and/or the like.

The computer 1112 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable instructions that, when executed by the processor, facilitate performance of operations, comprising:
determining that a mobile device is receiving a broadcast transmission of broadcast content from a broadcast enabled access point device that is configured to send the broadcast content to multiple devices via a point-to-multipoint communication protocol;
in response to receiving, from the mobile device, an interrupt request to interrupt the broadcast transmission, storing a copy of the broadcast content in a memory; and
in response to receiving a play request from the mobile device, initiating a transmission of a first portion of the copy of the broadcast content to the mobile device.

2. The system of claim 1, wherein the broadcast transmission comprises a long term evolution (LTE) enhanced multimedia broadcast multicast service (eMBMS) based transmission.

3. The system of claim 1, wherein the initiating the transmission comprises:
initiating a unicast transmission of the first portion of the copy of the broadcast content from a unicast enabled access point device that is configured to send the copy of the broadcast content to the mobile device via a point-to-point communication protocol.

4. The system of claim 3, wherein the broadcast enabled access point device comprises the unicast enabled access point device.

5. The system of claim 3, wherein the initiating the unicast transmission comprises:
initiating the unicast transmission utilizing a universal mobile telecommunication system terrestrial radio access network (UTRAN).

6. The system of claim 3, wherein the unicast enabled access point device comprises an Institute of Electrical and Electronics Engineers (IEEE) 802.XX based access point device.

7. The system of claim 1, wherein the storing the copy and the initiating the transmission are further in response to determining that the mobile device is not receiving the broadcast transmission.

8. The system of claim 1, wherein the operations further comprise:
in response to receiving, from a device, an alternate request to access the copy of the broadcast content, sending a second portion of the copy of the broadcast content directed to the device.

9. The system of claim 8, wherein the sending the second portion comprises:
sending the second portion of the copy of the broadcast content directed to the device utilizing an Internet protocol based communication.

10. The system of claim 1, wherein the operations further comprise:
in response to receiving, from the mobile device, a broadcast request to resume the broadcast transmission, halting the transmission and resuming the broadcast transmission of the broadcast content from the broadcast enabled access point device to the mobile device.

11. A method, comprising:
determining, by a system comprising a processor, that a user equipment (UE) is receiving a broadcast transmission of multimedia content from a broadcast access point device that is configured to send the broadcast transmission to multiple devices via a point-to-multipoint wireless communication protocol;
in response to receiving, by the system, a first request to interrupt the broadcast transmission, storing, by the system, a copy of the multimedia content in a memory; and
in response to receiving, by the system, a second request from the UE, the second request directed to access the multimedia content, sending, by the system, a first portion of the copy of the multimedia content directed to the UE.

12. The method of claim 11, wherein sending further comprises:
sending, via a unicast transmission, the first portion of the copy directed to the UE.

13. The method of claim 11, wherein the sending further comprises:
sending, via an Institute of Electrical and Electronics Engineers (IEEE) 802.XX based transmission, the first portion of the copy directed to the UE.

14. The method of claim 11, wherein the operations further comprise:
in response to receiving, by the system, a third request from the UE, the third request to resume the broadcast transmission, ending the sending and resuming the broadcast transmission of the multimedia content to the user equipment.

15. The method of claim 11, wherein the receiving the second request further comprises:
in response to determining that the UE is not receiving the broadcast transmission, sending a unicast transmission of the first portion of the copy directed to the UE.

16. The method of claim 11, wherein the operations further comprise:
in response to receiving, by the system, a third request from a device, the third request directed to access the multimedia content, sending, by the system, a second portion of the copy of the multimedia content directed to the device.

17. A machine-readable storage medium, comprising executable instructions that, when executed by a processor, facilitate performance of operations, comprising:
determining that a mobile device is receiving a broadcast transmission of a data stream via a point-to-multipoint wireless communication protocol;
in response to receiving an interrupt request to interrupt the broadcast transmission, storing a copy of the data stream in a memory device; and
in response to receiving a content request to access the data stream, sending a first portion of the copy directed to the mobile device.

18. The machine-readable storage medium of claim 17, wherein the sending comprises:
sending the first portion of the copy directed to the mobile device utilizing a unicast transmission.

19. The machine-readable storage medium of claim 17, wherein the operations further comprise:
in response to receiving a resume request from the mobile device, the resume request being to resume the broadcast transmission, halting the sending and resuming the broadcast transmission of the data stream to the mobile device.

20. The machine-readable storage medium of claim 17, wherein the operations further comprise:
in response to receiving an access request from a device, the access request being to access the copy of the data stream, sending a second portion of the copy of the data stream directed to the device.
